(19) United States
(12) Patent Application Publication
(10) Pub. No.: US 2006/0271415 A1
(43) Pub. Date: Nov. 30, 2006

(54) Customer insight at a common location

(75) Inventors: Hillery D. Simmons, Chicago, IL (US); Sanjay Mathur, Redwood City, CA (US); Adam Tarkowski, Chicago, IL (US); Charles Michael Portell, Chicago, IL (US)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(73) Assignee: Accenture Global Services GmbH, Schaffhausen (CH)

(21) Appl. No.: 11/120,805

(22) Filed: May 3, 2005

(51) Int. Cl. G06Q 99/00

(52) U.S. Cl. 705/5; 705/10; 705/14; 705/1

(57) ABSTRACT

Methods and apparatuses for gauging the effectiveness of advertising and to provide insight in delivering advertising and services at a common location. Identifying information is collected for each registered participant at a common location. Consequently, customer characterization is retrieved for each participant, combined with the identifying information, and aggregated to provide insight about advertising at the common location. Embodiments of the invention obtain identifying information from ticket information, which is used to retrieve demographic data for the identified customer, and support advertising at an airport that is based on the movement and characteristics of air travelers. Combined data may be correlated with non-customer data that may include information about the common location. Advertising is delivered to dynamically adjust to the movement of customers through the common location in accordance with customer characteristics.

### FIELD OF THE INVENTION

This invention relates generally to assessing advertising and services in a common location. More particularly, the invention provides methods and systems for gauging the effectiveness of advertising and services and to provide insight in delivering the advertising and services in a common location.

### BACKGROUND OF THE INVENTION

With the current technology and access to data, it is often difficult to provide valuable advertising and services in a location with a transient population. Associated activities include air traveling, shopping, and attending sports and entertainment events. Corresponding locations span different venues, including airports, shopping malls, and sports arenas. Populations are typically dynamic, in which the size and characteristics vary as a function of time, day, and season.

Many industries rely on understanding the customer to improve their businesses (e.g., profitability), for example, by improving sales through better and more directed marketing. Being able to assess the effectiveness of advertising in a location, a company can spend advertising dollars that result in increased profits. However, current advertising approaches typically rely on unmeasured rules such as business travel schedules and airport layout diagrams. Very little information is typically gathered or used to support decisions about advertising processes. Consequently, it is difficult to understand and respond to a customer base in a location.

Therefore, there exists a need in the art for systems and methods that enable a company to quantify the effectiveness of advertising and services in a location and to obtain an understanding for improving advertising and services delivery.

### BRIEF SUMMARY OF THE INVENTION

The present invention provides methods and apparatuses to provide insight in delivering the advertising and services in a common location.

With one aspect of the invention, identifying information is collected for each registered participant at a common location. Consequently, customer characterization data is retrieved for each participant and is combined with the identifying information. The combined data is aggregated for the group of registered participants to provide insight about the advertising at the common location. Embodiments of the invention obtain identifying information from ticket information, which is used to retrieve demographic data for the identified customer.

With another aspect of the invention, a registered participant includes a customer who has purchased a service or product or participated in a shared activity that requires the customer to be at a common location at a predetermined time. Embodiments of the invention support advertising at an airport that is based on the movement and characteristics of air travelers.

With another aspect of the invention, combined data is correlated with non-customer data that may include information about the common location. Embodiments of the invention correlate information about the customer with layout information about the common location. Advertising is delivered or services are provided to dynamically adjust to the movement of customers through the common location in accordance with customer characteristics.

### BRIEF DESCRIPTION OF THE DRAWINGS

The present invention is illustrated by way of example and not limited in the accompanying figures in which like reference numerals indicate similar elements and in which:

FIG. 1 shows a computer system that supports an embodiment of the invention.

FIG. 2 shows an architecture to determine insight about customers in an airport in accordance with an embodiment of the invention.

FIG. 3 depicts airport activity according to an embodiment of the invention.

FIG. 4 shows a snapshot in time of an airport according to an embodiment of the invention.

FIG. 5 shows an exemplary insight report according to an embodiment of the invention.

FIG. 6 shows a flow diagram that processes ticketing and actual flight flown data according to an embodiment of the invention.

FIG. 7 shows a flow diagram that appends customer data from an airline in accordance with an embodiment of the invention.

FIG. 8 shows a flow diagram that appends customer data in accordance with an embodiment of the invention.

FIG. 9 shows a flow diagram that updates advertisements in accordance with an embodiment of the invention.

FIG. 10 shows an architecture that collects and processes customer information to target customer ads in accordance with an embodiment of the invention.

FIG. 11 shows an architecture that utilizes a sensor network and a customer characterization data source to provide insight about individuals in accordance with an embodiment of the invention.

FIG. 12 shows a flow diagram for a process that provides insight in accordance with an embodiment of the invention.

### DETAILED DESCRIPTION OF THE INVENTION

In the following description, a registered participant is known to a computer system by at least one attribute that is uniquely associated with the registered participant. A registered participant may be explicitly associated with a group through a purchase of a product or service or may be implicitly associated with a common location by being co-located at the common location. The at least one attribute may be obtained in numerous ways. For example, ticketing information may provide a customer's name with the customer's flight information. As another example, a sensor network may distinguish a person by an attribute. The person may be identified by name or may be described without providing a name for privacy reasons. Registered participants may be co-located for different reasons. For example, registered participants may have purchased a product or service. Other examples, do not require a purchase of a product or service. For example, people may be considered registered participants by their presence in a shopping mall without any required purchases. Examples of a common location include an airport, a sporting venue, and a shopping mall. A common location may be accessible to the public (e.g., an airport) or may be restricted (e.g., a military installation). Viewership is a set of co-located people defining the group being analyzed.

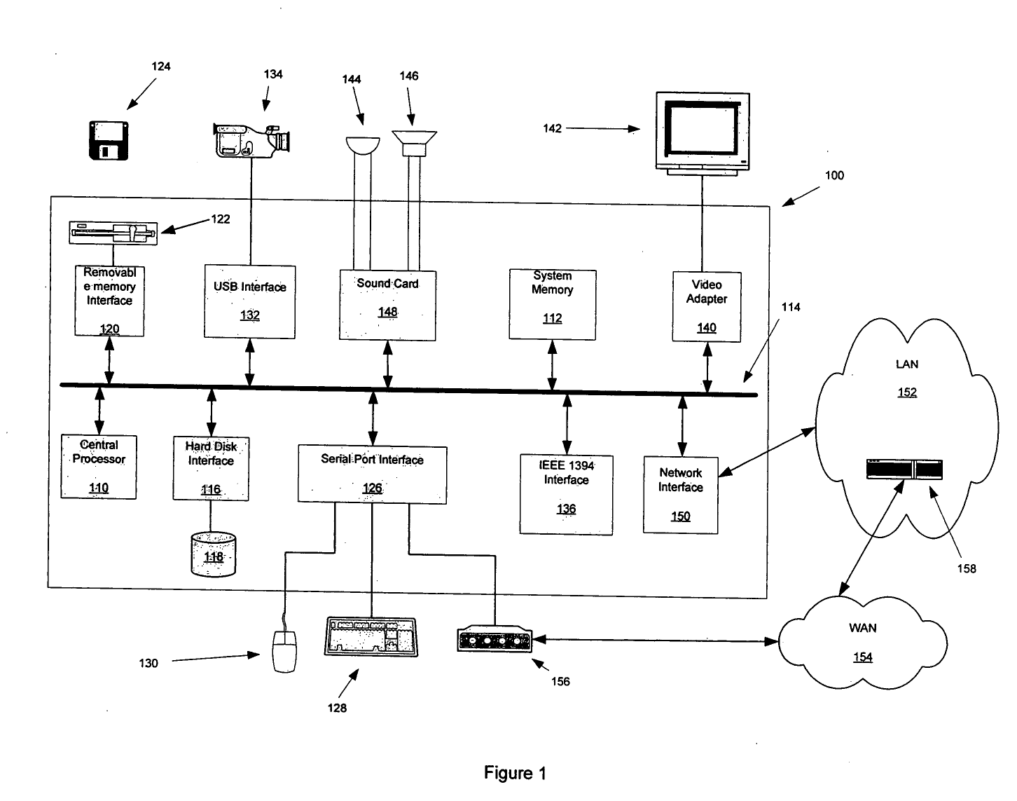

Elements of the present invention may be implemented with computer systems, such as the system 100 shown in FIG. 1. (System 100 may support apparatus 700 as will be discussed.) Computer 100 includes a central processor 110, a system memory 112 and a system bus 114 that couples various system components including the system memory 112 to the central processor unit 110. System bus 114 may be any of several types of bus structures including a memory bus or memory controller, a peripheral bus, and a local bus using any of a variety of bus architectures. The structure of system memory 112 is well known to those skilled in the art and may include a basic input/output system (BIOS) stored in a read only memory (ROM) and one or more program modules such as operating systems, application programs and program data stored in random access memory (RAM).

Computer 100 may also include a variety of interface units and drives for reading and writing data. In particular, computer 100 includes a hard disk interface 116 and a removable memory interface 120 respectively coupling a hard disk drive 118 and a removable memory drive 122 to system bus 114. Examples of removable memory drives include magnetic disk drives and optical disk drives. The drives and their associated computer-readable media, such as a floppy disk 124 provide nonvolatile storage of computer readable instructions, data structures, program modules and other data for computer 100. A single hard disk drive 118 and a single removable memory drive 122 are shown for illustration purposes only and with the understanding that computer 100 may include several of such drives. Furthermore, computer 100 may include drives for interfacing with other types of computer readable media.

A user can interact with computer 100 with a variety of input devices. FIG. 1 shows a serial port interface 126 coupling a keyboard 128 and a pointing device 130 to system bus 114. Pointing device 128 may be implemented with a mouse, track ball, pen device, or similar device. Of course one or more other input devices (not shown) such as a joystick, game pad, satellite dish, scanner, touch sensitive screen or the like may be connected to computer 100.

Computer 100 may include additional interfaces for connecting devices to system bus 114. FIG. 1 shows a universal serial bus (USB) interface 132 coupling a video or digital camera 134 to system bus 114. An IEEE 1394 interface 136 may be used to couple additional devices to computer 100. Furthermore, interface 136 may configured to operate with particular manufacture interfaces such as FireWire developed by Apple Computer and i.Link developed by Sony. Input devices may also be coupled to system bus 114 through a parallel port, a game port, a PCI board or any other interface used to couple and input device to a computer.

Computer 100 also includes a video adapter 140 coupling a display device 142 to system bus 114. Display device 142 may include a cathode ray tube (CRT), liquid crystal display (LCD), field emission display (FED), plasma display or any other device that produces an image that is viewable by the user. Additional output devices, such as a printing device (not shown), may be connected to computer 100.

Sound can be recorded and reproduced with a microphone 144 and a speaker 166. A sound card 148 may be used to couple microphone 144 and speaker 146 to system bus 114. One skilled in the art will appreciate that the device connections shown in FIG. 1 are for illustration purposes only and that several of the peripheral devices could be coupled to system bus 114 via alternative interfaces. For example, video camera 134 could be connected to IEEE 1394 interface 136 and pointing device 130 could be connected to USB interface 132.

Computer 100 can operate in a networked environment using logical connections to one or more remote computers or other devices, such as a server, a router, a network personal computer, a peer device or other common network node, a wireless telephone or wireless personal digital assistant. Computer 100 includes a network interface 150 that couples system bus 114 to a local area network (LAN) 152. Networking environments are commonplace in offices, enterprise-wide computer networks and home computer systems.

A wide area network (WAN) 154, such as the Internet, can also be accessed by computer 100. FIG. 1 shows a modem unit 156 connected to serial port interface 126 and to WAN 154. Modem unit 156 may be located within or external to computer 100 and may be any type of conventional modem such as a cable modem or a satellite modem. LAN 152 may also be used to connect to WAN 154. FIG. 1 shows a router 158 that may connect LAN 152 to WAN 154 in a conventional manner.

It will be appreciated that the network connections shown are exemplary and other ways of establishing a communications link between the computers can be used. The existence of any of various well-known protocols, such as TCP/IP, Frame Relay, Ethernet, FTP, HTTP and the like, is presumed, and computer 100 can be operated in a client-server configuration to permit a user to retrieve web pages from a web-based server. Furthermore, any of various conventional web browsers can be used to display and manipulate data on web pages.

The operation of computer 100 can be controlled by a variety of different program modules. Examples of program modules are routines, programs, objects, components, and data structures that perform particular tasks or implement particular abstract data types. The present invention may also be practiced with other computer system configurations, including hand-held devices, multiprocessor systems, microprocessor-based or programmable consumer electronics, network PCS, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

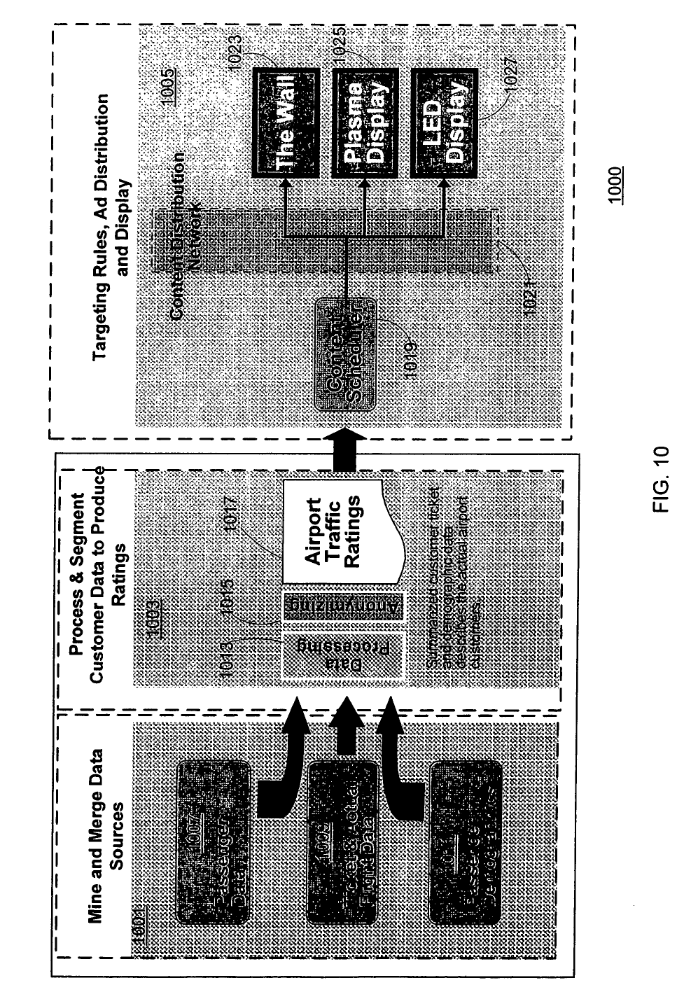

Ticketing information, customer characterization data, and non-customer data (as will be discussed) may be obtained from a data source (not shown) from LAN 152, WAN 152, the Internet, or from a database stored on hard disk 118. In embodiments of the invention, sensor information about participants may be obtained from a sensor network (shown as 1001 in FIG. 10) that may be interfaced, for example, through USB interface 132 or serial port interface 126.

Embodiments of the invention may use a subset of the components shown in FIG. 1. Embodiments of the invention may use also use components that are not shown in FIG. 1, e.g., RFID devices, tracking cameras, weather measurement devices, and other sensors.

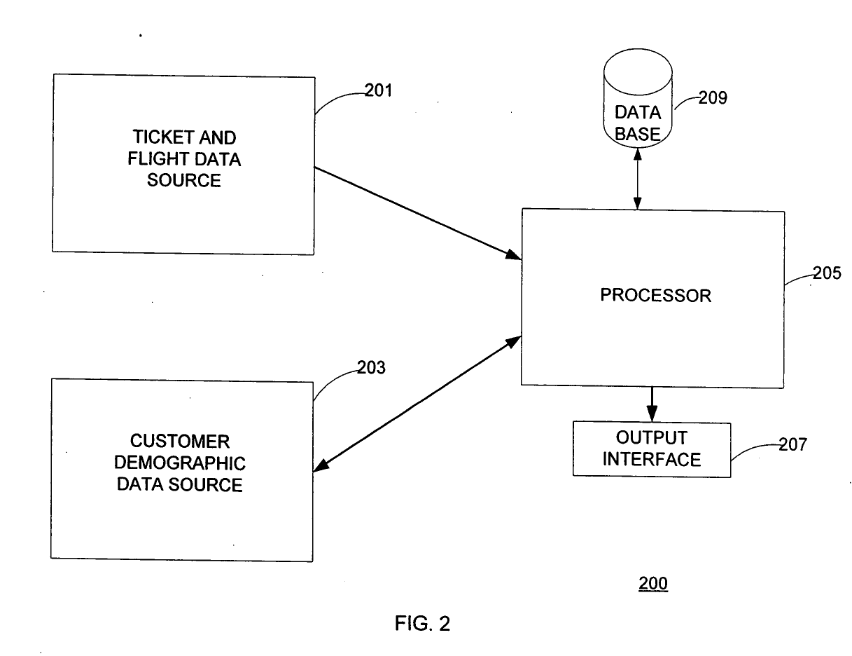

FIG. 2 shows architecture 200 to determine insight about customers in an airport in accordance with an embodiment of the invention. An embodiment of the invention utilizes architecture 200 to support an airport customer insight (ACI) system. Architecture 200 comprises ticket and flight data source 201, customer demographic data source 203, processor 205, output interface 207, and database 209. Architecture 200 supports embodiments in which elements 201-209 may be owned and/or controlled by the same business entity or by different business entities. As will be discussed, data as provided by different business entities may be provided in an anonymous manner (“anonymized”) in order to protect the privacy of participants.

With an embodiment of the invention, customer travel initiates with the ticketing process at a reservations system (not shown). Ticketing and flight information for the customer is stored and updated in data source 201. Tickets are subsequently audited for correct application of rules and fares. The itinerary information available at this stage provides an advance expected view of airport traffic. Once a customer goes to the airport to commence travel, the customer is issued a boarding pass by the airline and is then tracked as the customer either uses the pass to board a flight or exchanges it (for example as standby). As each flight departs, data source 201 may be updated detailing the passengers on the plane. Data may reflect cost apportions of the flight (fare, taxes, fees) by flight leg/segment for the airline in order to report revenue as it is accrued. Thus, planned traffic information in data source 201 may be adjusted for actual flight activity by the customer.

Data source 203 provides customer demographic data. In an embodiment of the invention, data source 203 provides demographic data that includes the age, race, home ownership, family, employment, hobby, and financial information about a customer.

Processor 205 processor merges data from ticket and flight data source 201 and customer demographic data source 203. Data source 201 includes customer information for a customer and is related with a service or product that is associated with a common location for a group of customers. Data source 203 stores customer characterization data (e.g., customer demographic data) that characterizes the customer. Processor 205 merges the data on a per customer basis, which can be later aggregated in order to “anonymize” the merged data. The aggregated data is further processed to provide traffic metrics in near real time. (“Near real time” pertains to the delay introduced, by automated processing, between the occurrence of an event and the use of the processed data, e.g., for display or feedback and control purposes. For example, a near real time display depicts an event or situation as it existed at the current time less the processing time.)

In embodiments of the invention, processor 205 may merge data about a customer, the customer's actions, the common location, and other related information to form one unified “view” of the customer in the common location. Data sources may reflect customer business interactions that include purchases and purchase habits, customer loyalty affiliations, and business patronage. Database 209 may provide additional data that includes intended or actual location information, including travel itineraries, location-based sales transactions, sensed data (customer identification and location information gathered through technological means), and calendar/schedule data.

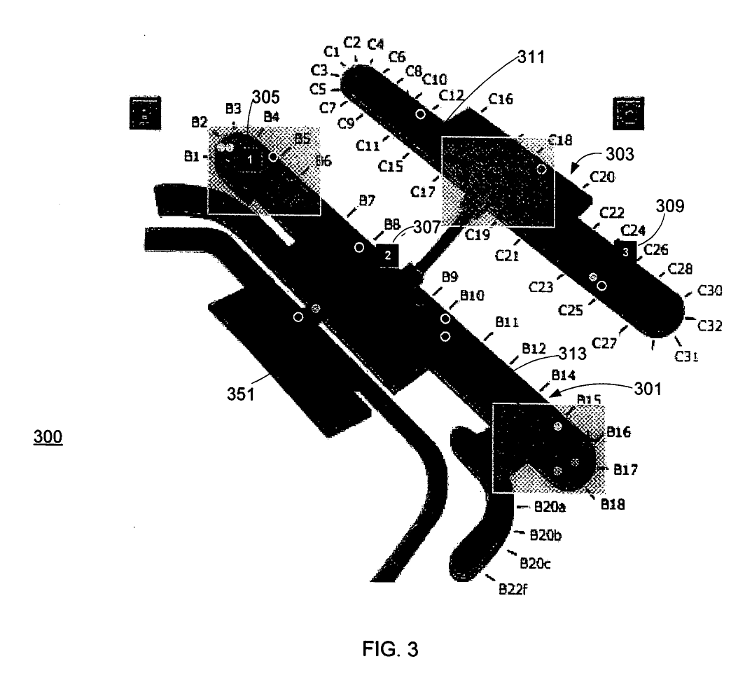

In embodiments of the invention, database 209 may provide non-customer data. For example, non-customer data may include layout data of an airport (as will be further discussed with FIG. 3) so that processor 205 can analyze customers with the non-customer data in conjunction with customer characterization data and ticketing information. Non-customer data may also include weather information and event information that do not directly relate to the customer.

Processor 205 merges the data from different data sources (e.g., data sources 201 and 203 and database 209) to obtain insight about a group of registered participants. The determined insights provide information that is discovered from the merged data. Actions are consequently enabled to respond to, enhance, understand, or communicate the customer's experience. Determined insights may include:
Customer attributes and segments that comprise a transient population. For example, customer paths (e.g., paths 311 and 313 shown in FIG. 3) through a common location are determined through sensing or through intelligent extrapolation of point-in-time locations (either intended or actual).
Advertising reach for ad space in a common location. For example, the number of people passing by/through a common location during a timeframe, in total or broken into groups using customer attributes/segments, may be determined. In addition to supporting advertising, embodiments of the invention support an ability to deliver services based on an understanding of the people in an area of a common location, e.g., determining product stocking for a vendor at an airport or predicting demand for wireless hotspots for areas within the airport.
Advertising frequency for ad space in a common location. For example, a summary of how many times a customer has taken a path passing by/through a common location during a timeframe, in total or broken into groups using customer attributes/segments, may be determined.
Historical trends or patterns. Insight may provide a break-down of how customer segments, paths, or other insights change or become predictable over time

Processor 205 may utilize intelligent algorithms and assumptions to process data from data sources 201 and 203 and database 209. In an embodiment of the invention, processor 205 may merge and process data from data sources 201 and 203 and databases 209 to provide an insight regarding:
Transactional data is collected and merged from-which reference data is built and maintained.
For each person in the data set, the known location and time data points are collected and mapped to a path.
Likelihood percentages are applied to points along the path indicating the chance that a person would be at that location along the path during various timeframes.
Areas along the path are defined for analysis (e.g., the area around an advertisement delineating the effective ad viewing space).
Person location likelihood percentages are aggregated for the defined path areas to create location-centric views of customer traffic.
Customer attributes for customers within a path area are summed and combined to form base traffic metrics. Base traffic metrics and customer paths are analyzed for trends.

With insight information derived by processor 205, a business may be able to respond to the business's customer base in a co-located environment. Resulting responses include:
Customer segmentation (customer relationship management) applications
Advertising, campaign management, and marketing decisions
Operational support for the management of the location/environment
Customer or Customer Services analysis
Competitor Customer analysis

By merging (combining) flight data from data source 201 with information about passenger demographics from data source 203, processor 205 provides a near real-time summary of statistics of who is at the airport to optimize decisions of advertisers, airlines, and airport operators.

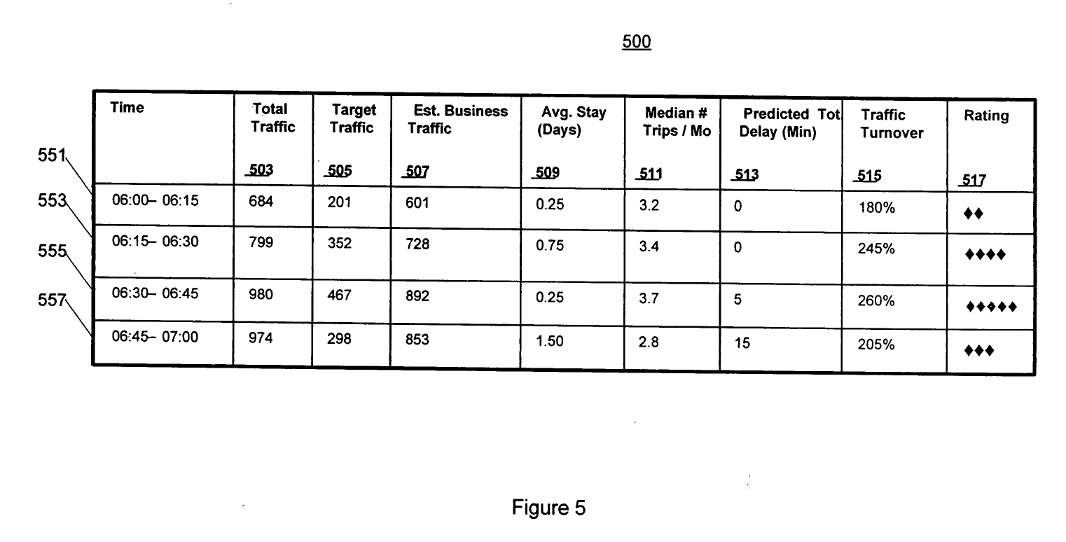

Processor 205 outputs results through output interface 207. Results include a summary report (e.g., insight report 500 as will be discussed with FIG. 5) and output to control advertising displays (e.g., ad distribution and display 1005 as will be discussed with FIG. 10). Output results may be provided in a number of ways. For example, a file (in a PDF, XML or web services format) or a control signal may be transmitted to another system through output interface 207.

FIG. 3 depicts airport activity of airport 300 according to an embodiment of the invention. Airport 300 comprises terminal 301 and terminal 303. Ad locations 305, 307, and 309 are positioned at selection locations of terminals 301 and 303. Processor 205 utilizes location/environment information of airport 300 (e.g., from database 209 as shown in FIG. 2) to obtain information that may include location floor plan/layout, location traffic flow patterns, location internal conditions (e.g. temperature, volume, humidity), location external conditions (e.g. weather, climate), and local area information (e.g. local business proximity, local event schedules). From airport layout information (e.g., from database 209) and ticketing information (e.g., from data source 201) processor 205 may predict a path of a customer (e.g., path 311 or 313) if the customer is originally located at entrance 351.

Ad targeting (e.g., ad locations 305, 307, and 309) is the process of dynamically altering advertising content to viewers based on marketing campaigns. In order to support ad targeting in an airport application, ticketing and customer demographic information are needed to determine the viewership at the airport. Viewership information may be provided in the form of a data subscription service. By the nature of the mass movement of people through an airport and in support of consumer sensitivity around privacy, data is provided in a summarized format (i.e., the data is “anonymized”). For example, counts of people may be provided by day/time, by airport terminal/gate, and by demographics.

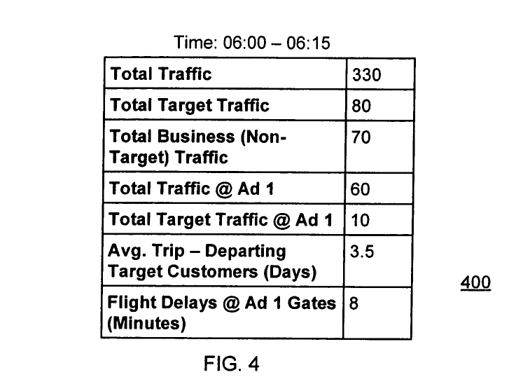

FIG. 4 shows snapshot 400 (corresponding to the 15-minute time between 06:00-06:15) of airport 300 according to an embodiment of the invention. While processor 205 may predict traffic based on insight, processor 205 may also utilize sensory information (as will be discussed with FIG. 10). Snapshot 400 shows the total traffic (corresponding to terminals 301 and 303) as well as traffic corresponding to ad location 305.

FIG. 5 shows insight report 500 according to an embodiment of the invention. Insight report 500 provides a user metrics 503-517 for time intervals 551-557. For example, target traffic metric 505 indicates the number of target customers that will see an advertiser's ad. Estimated business traffic metric 507 indicates whether the people seeing the ad are interested in hearing about the product. Average stay metric 509 indicates whether there is a time-critical or current event based message that should be portrayed to the customers. Median trips metric 511 indicates the number of customers that have seen the ad before. Traffic turnover metric 515 indicates how fast traffic is moving past the ad (i.e., how much exposure will customers get).

Insight report 500 provides base traffic metrics that may include:
Total Traffic Count—Count of all customers passing through a path area during a defined period of time
Target Traffic Count—Count of customers with specified characteristics passing through a path area during a defined period of time
Business Traffic Count—Count of customers traveling for business that pass through a path area during a defined period of time
Average Stay—The average number of days before arriving customers are scheduled to depart
Average Trips Per Month—The average number of trips that customers take through that airport or terminal or gate during a month based on past tickets
Predicted Average Minutes Delayed—The average number of minutes that customers will be delayed from departing flights. Prediction basis includes but is not limited to use of historical flight trends, weather, airport analysis, and plane maintenance history.
Traffic Density—The traffic divided by the measured square footage of the path area
Traffic Frequency—The average number of times that the customers in a path area have previously passed through that path area during a defined period of time
Percentage Target Traffic of Business Traffic
Average Stay for Arriving vs. Departing Passengers
Percentage of Traffic not yet exposed to specific ad
Passenger travel by day of week
Passenger travel by time of day
Flying frequency
Percentage of Target 1 Traffic vs. Target 2 Traffic
Arriving passengers by region of country departing
Departing passengers by length of flight
% Passengers with Saturday night stay
Connecting passengers by connection gate distance
Connecting passengers by length of layover

From the provided metrics, an advertiser can gain insight on different perspectives including services that customers want during their travel experience, what items should be stocked, which in-flight services that air travelers would be interested in purchasing, which customers that competitors are attracting, improving gate planning to make sure more customers can make their connections, determining whether airport advertising is effective, determining the number of people seeing an ad, and placing ads at the right times and locations to target the best audience for the product.

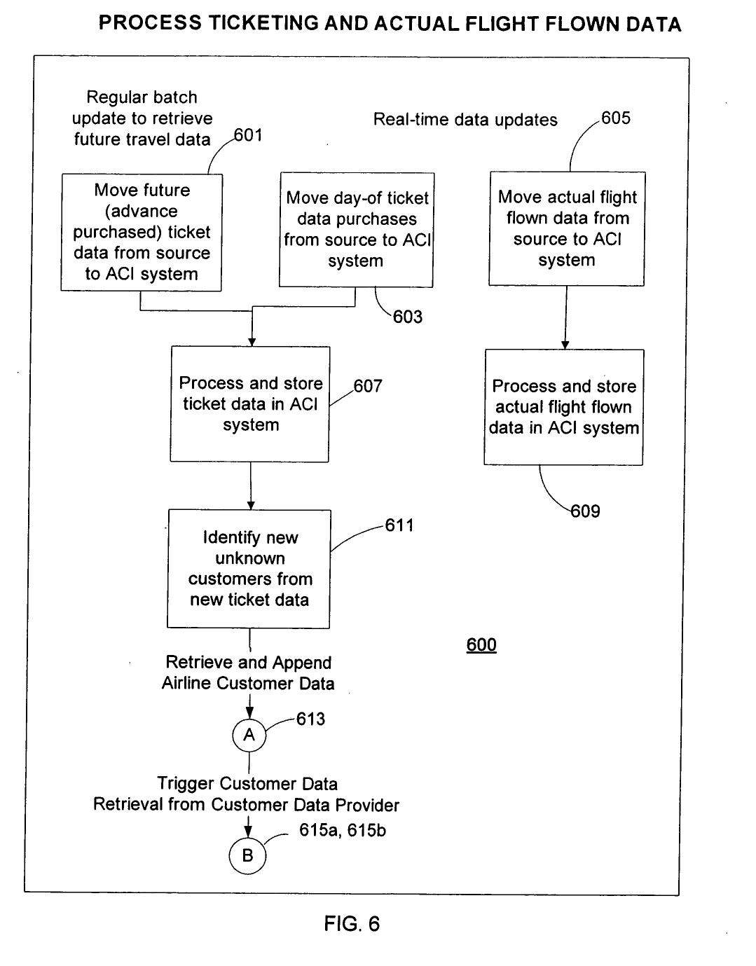

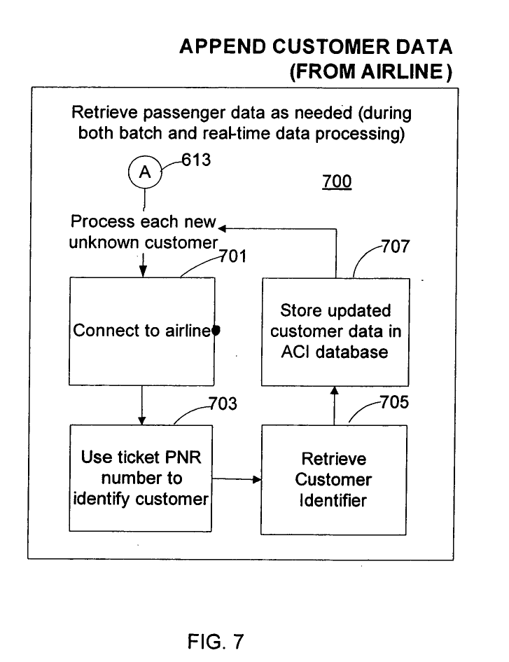

FIG. 6 shows flow diagram 600 that processes ticketing and actual flight flown data according to an embodiment of the invention. Process 600 provides ticket and actual flight data and, as shown in FIG. 7, process 700 provides passenger data that is associated with the ticket and actual flight data. (Flow diagrams 600, 700, and 800 may be implemented with a processor, e.g., processor 205 as shown in FIG. 2 or processor 1005 as shown in FIG. 10.)

In process 600, regular batch updates are obtained to retrieve future travel data in step 601. Real-time data updates are provided by steps 603 and 605. Both advance purchased ticket data and day-of ticket purchases are stored in an airport customer insight (ACI) system in step 607 (as may be supported by architecture 200). New unknown customers are identified from new ticket data in step 611. Consequently, airport customer data is retrieved and appended in step 613 (as provided by process 700) and customer characterization data is retrieved from a customer service provider in steps 615a and 615b (as provided by process 800). Actual flight flown data as obtained in step 605 is processed and stored in the ACI system in step 609.

FIG. 7 shows flow diagram 700 that appends customer data from an airline in accordance with an embodiment of the invention. Process 700 retrieves passenger data as needed during both batch and real-time data processing of process 600. In process 700, each new unknown customer is processed (corresponding to step 611). (If the customer is already known, then process 700 is not executed for the customer.) In steps 701-707, a customer identifier is obtained from the ticket PNR number. The customer information is stored in the ACI database in step 707. Process 800 is subsequently executed with the customer identifier to retrieve customer characterization data.

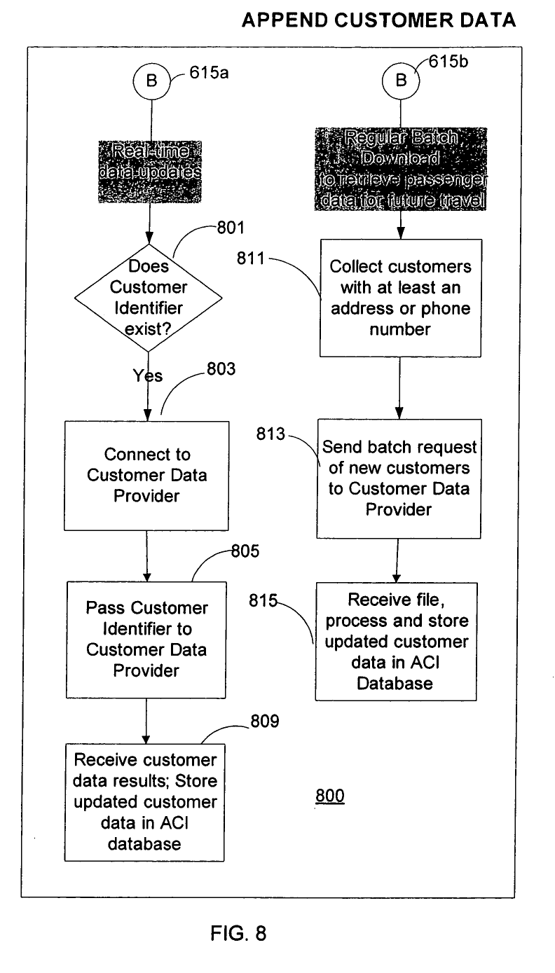

FIG. 8 shows flow diagram 800 that appends customer characterization data in accordance with an embodiment of the invention. (For example, customer characterization data includes customer demographic data.) Step 615a performs real-time data updates in steps 801-809. Step 615b performs regular batch downloading to retrieve passenger data for future travel in steps 811-815. The retrieved customer characterization data is stored in the ACI system in steps 809 and 815. Step 801 may determine that a customer identifier does not exist. Some individuals may not be identifiable for customer demographic data appends. All data that it retrievable is stored. When creating data reports, some individuals may be excluded from the calculations based on data availability. For instance, someone with no customer characterization data may still be included in an overall count but not a metric for specific kinds of counts. An embodiment provides an estimated margin of error for the metrics to account for irretrievable data.

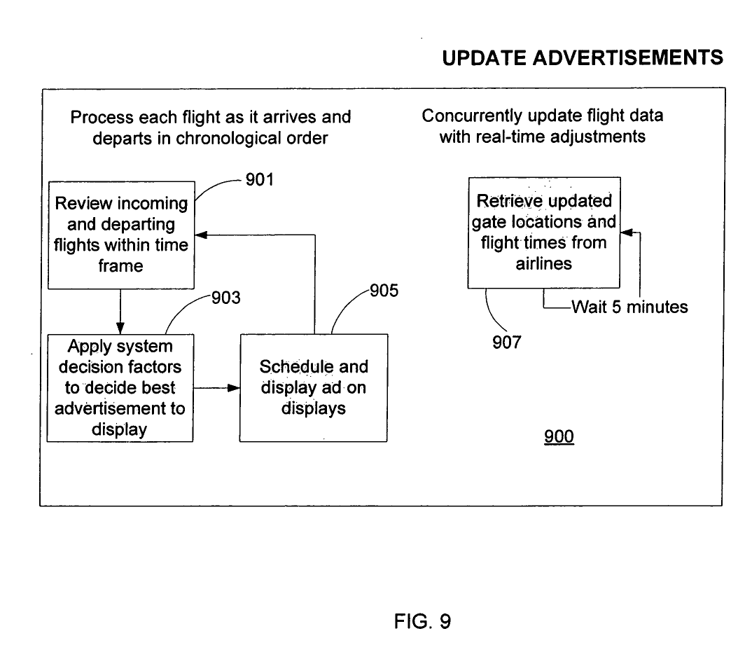

FIG. 9 shows flow diagram 900 that updates advertisements at airport 300 in accordance with an embodiment of the invention. In step 901, incoming and departing flights are reviewed within a desired timeframe. In step 903 determines the best advertisement to display using the information from step 901. For example, a pharmaceutical company with a new allergy medication dynamically places advertisements in real time at departure and arrival cities with prevailing weather conditions that promote allergies. Additionally, ad locations are prioritized at the airports based on gates with flights whose customers' health and age profiles indicate they are most susceptible to allergies. As another example, an airport restaurant monitors the closest gates for arriving flights that have been delayed. The restaurant then advertises their ready-to-go foods dynamically at the appropriate gate for flights over three hours that did not serve food or flights arriving during key meal times. In step 905, the selected advertisements are scheduled and displayed. Step 905 retrieves flight information every 5 minutes to provided updated flight information in step 901.

FIG. 10 shows architecture 1000 that collects and processes customer information to target customer ads in accordance with an embodiment of the invention. Data sources 901 include passenger data source 1007, ticket and actual flight data source 1009, and passenger demographics data source 1011. Referring to architecture 200, passenger data source 1007 and ticket and actual flight data source 1009 corresponds to data source 201 to provide identifying information about each registered participant. Passenger demographics data source 1011 corresponds to data source 203 to provide customer characterization data.

Processing unit 1003 (corresponding to processor 205 in FIG. 2) performs data processing procedure 1013 to combine (merge) data from sources 1001 and to obtain insight from the data. The data is aggregated in procedure 1015 in order to “anonymize” the data to protect the identities of the registered participants. Procedure 1017 uses the aggregated data in procedure 1017 to provide outputted results. The outputted results may be a summary report (e.g., report 500 as shown in FIG. 5) and/or a control signal that controls ad distribution and display system 1005.

In order to control advertising content, a control signal through content scheduler 1019 and content distribution network 1021 determines when, and what advertising content should be displayed on wall display 1023, plasma display 1025, and LED display 1027. Consequently, advertising content may be altered temporally and/or spatially in accordance with traffic metrics that are updated in near real time. Dynamic ad targeting benefits the airport, ad space resellers, advertisers, and the ad viewing public. The cost models enabled through dynamic ad targeting (for example by day part or viewership volume) support earning additional revenue from existing advertising space. Advertisers are able to reach their desired audience and measure their advertising exposure, and consumers are provided with more relevant and engaging content. Displays 1023-1027 may be positioned at the same approximate location or at different locations.

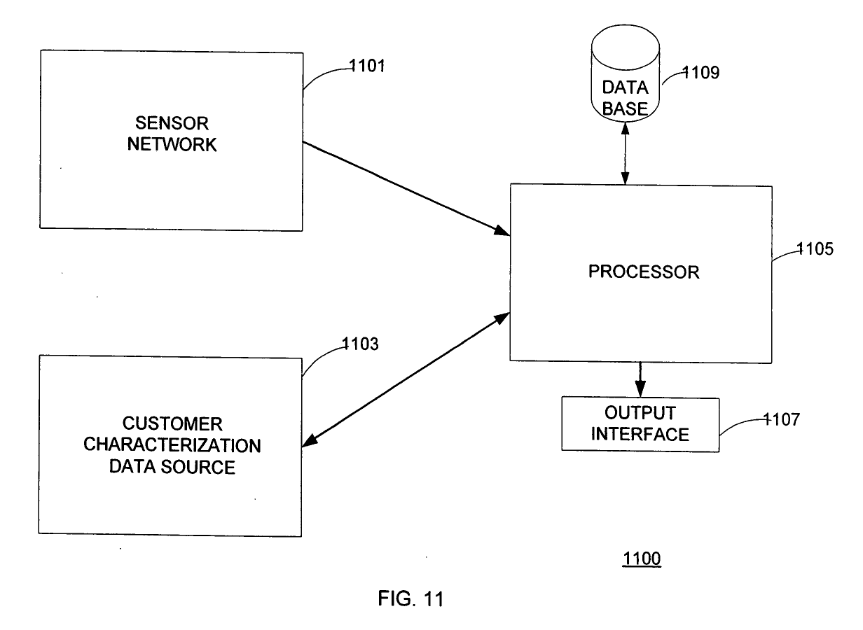

FIG. 11 shows system 1100 that utilizes sensor network 1101 and customer characterization data source 1103 to provide insight about individuals in accordance with an embodiment of the invention. Sensor network 1101 is distributed in a common location. For example, airport 300 may use different technologies, e.g., as sensors, RFID, biometric devices to identify and locate individuals. In an embodiment, sensor network 1101 provides at least one attribute about an individual. The least one attribute may be used as a key to customer characterization data source 1103 or database 1109 to retrieve data about the individual who is consequently registered by the at least one attribute without identifying the customer by name. Processor 1105 combines the data from sensor network 1101, data source 1103, and database 1109 to obtain insight about a group of individuals. Processor 1105 provides an outputted result, e.g., a report or control signal, to output interface 1107.

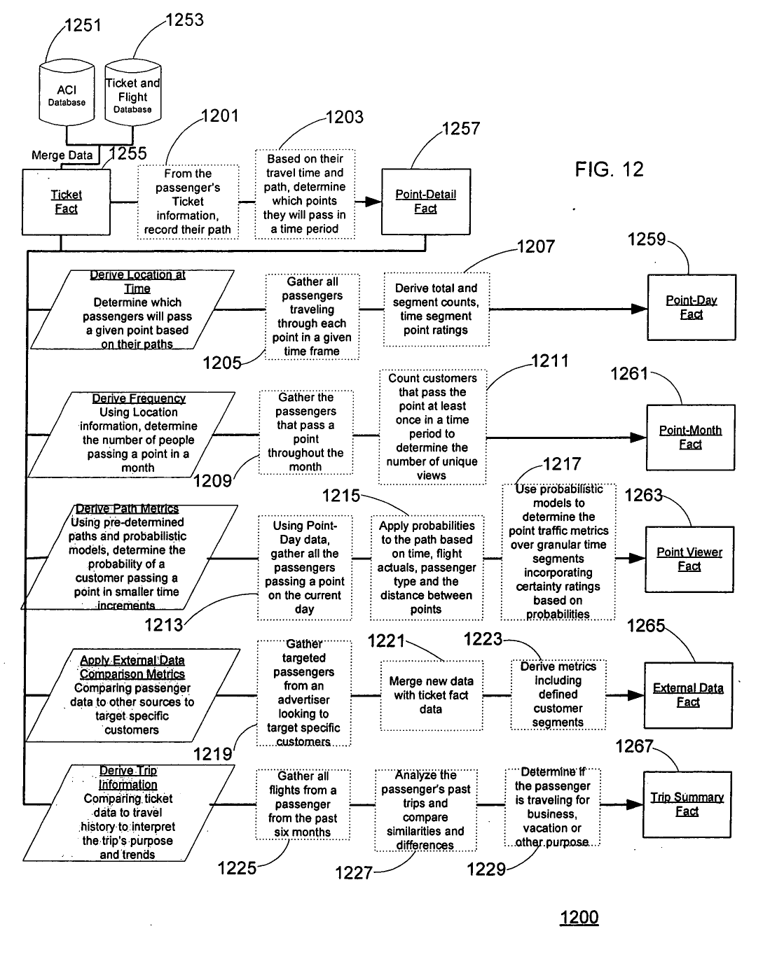

FIG. 12 shows a flow diagram for process 1200 that provides insight for airport 300 in accordance with an embodiment of the invention. Ticket data 1255 is obtained from databases 1251 and 1253. Using ticket data 1255, steps 1201 and 1203 determine points in airport 300 that a passenger will pass in a time period to form point-detail data 1257. Point-detail data 1257 is used by process 1200 to determine point-day data 1259, point-month data 1261, point-viewer data 1263, external data 1265, and trip summary data 1267 as will be discussed.

Point-day data 1259 is obtained by determining which passengers will pass a given point based on their paths in steps 1205-1207. Point-month data 1261 is obtained by determining the number of people passing a point in a month using location information in steps 1209-1211. Point viewer data 1263 is obtained by determining the probability of a customer passing a point in smaller time increments using pre-determined paths and probabilistic models in steps 1213-1217. External data 1265 is obtained by comparing passenger data to other sources to target specific customers in steps 1219-1223. Trip summary data is obtained by comparing ticket data to travel history to interpret the trip's purpose and trends in steps 1225-1229.

Embodiments of the invention may process data from different sources in order to provide insight. For example, data may be obtained from airlines, data providers (e.g., demographic data and flight information), air traffic control, weather services, sensors, an airport traffic path database that provides airport layout information, and databases that provide customer information from other businesses.

As can be appreciated by one skilled in the art, a computer system with an associated computer-readable medium containing instructions for controlling the computer system may be utilized to implement the exemplary embodiments that are disclosed herein. The computer system may include at least one computer such as a microprocessor, a cluster of microprocessors, a mainframe, and networked workstations.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A method for deriving insight relative to a group of occupants at a common location, the method comprising:
(a) obtaining identifying information for each registered participant;
(b) using the identifying information to obtain customer characterization data for each said registered participant;
(c) combining the identifying information and the customer characterization data to form combined data; and
(d) aggregating the combined data for each said registered participant to obtain a characterization profile of the group of participants.

2. The method of claim 1, wherein the group of registered participants comprises members who have purchased a service that requires the members to be in a predetermined location at a predetermined time.

3. The method of claim 1, wherein (a) comprises extracting identification information from a ticket.

4. The method of claim 1, wherein the customer characterization data includes customer demographic data.

5. The method of claim 1, further comprising:
(e) correlating the combined data with non-customer data.

6. The method of claim 5, wherein the non-customer data characterizes the common location.

7. The method of claim 1, wherein the group of registered participants comprises members who are located at a predetermined location at a predetermined time.

8. The method of claim 7, wherein the predetermined location and the predetermined time are based on a purchase of a product or a service.

9. The method of claim 7, wherein the predetermined location and the predetermined time are based on a use of a product or a service.

10. The method of claim 7, wherein the predetermined location and the predetermined time are based on an experience.

11. The method of claim 1, further comprising:
(d) trending the combined data over a period of time to form trended data.

12. The method of claim 11, further comprising:
(e) predicting the characterization profile from the trended data.

13. The method of claim 6, wherein (e) comprises:
(e)(i) determining a path of at least one registered participant through the common location.

14. The method of claim 13, wherein (e)(i) comprises:
(e)(i)(1) extrapolating movement of the at least one registered participant from a predetermined location and a predetermined time.

15. A method for deriving insight relative to a group of customers at an airport, comprising:
(a) obtaining ticket data for at least one customer of the group of customers;
(b) obtaining customer data for each of the at least one customer;
(c) merging the ticket data and the customer data for each of the at least one customer to form merged data for each of the at least one customer;
(d) correlating the merged data with location data to form correlated data, the location data characterizing the airport; and
(e) aggregating the correlated data to form a traffic metric.

16. The method of claim 15, further comprising:
(f) providing an advertisement at a determined area based on the traffic metric.

17. The method of claim 15, wherein (d) comprises:
(i) determining a number of customers from the group of customers for a specified location within the airport during a specified period of time.

18. An apparatus that derives insight relative to a group of registered participants for a common location, the apparatus comprising:
a data gathering module that collects customer information and customer characterization data for at least one of the registered participants, wherein the customer information is associated with a product or service purchased by the at least one registered participant, and wherein the customer characterization data profiles the at least one registered participant; and
a data processing module that merges the customer information and the customer characterization data to form merged data, correlates the merged data with non-customer data to form correlated data, and aggregates the correlated data to form aggregated data.

19. The apparatus of claim 18, further comprising:
a presentation module that causes content to be presented at the common location based on the aggregated data.

20. The apparatus of claim 18, wherein the data processing module predicts movement of the at least one participant within the common location.
